(19) United States
(12) Patent Application Publication
(10) Pub. No.: US 2013/0303250 A1
(43) Pub. Date: Nov. 14, 2013

(54) Method of Playing a Card Game

(71) Applicant: Ryan Moore, Hamilton (CA)

(72) Inventor: Ryan Moore, Hamilton (CA)

(21) Appl. No.: 13/470,248

(22) Filed: May 11, 2012

(51) Int. Cl. A63F 1/00; A63F 13/00

(52) U.S. Cl. 463/16; 273/304

(57) ABSTRACT

A method of playing a card game with at least one player is disclosed. The method comprises providing a plurality of cards and requiring the player(s) to announce at least one bet on an outcome of a set of drawn cards from the plurality of cards, the bet predicting a suit, denomination, or color of a first drawn card from the set of drawn cards, or the suits, denominations, or colors of the set of drawn cards. A first card is drawn and the bets are evaluated. Three additional cards are drawn from the plurality of the cards and any bets predicting the set of cards are evaluated.

### FIELD OF THE INVENTION

The invention relates card games, particularly table card games and internet card games.

### BACKGROUND OF THE INVENTION

Card games have become ubiquitous throughout society. People play card games for entertainment, and occasionally for profit. Various card games have been developed in the past, such as blackjack, poker, or baccarat. These types of card games, in which the player attempts to approach a predetermined value or collect cards with particular suits or denominations, rely on the player's ability to accurately and quickly determine a winning and losing hand. Some card games have complex rules and are difficult for inexperienced players. To compound the problem, some games are played at an extremely fast pace, especially at a professional or casino level. Thus, it can be difficult and perhaps uninviting to a novice player to keep up with the pace of a complex game.

Accordingly, there is a need for a card game that can be easily and successfully played with only basic knowledge of the rules, without sacrificing the speed of play.

### BRIEF SUMMARY OF THE INVENTION

The present invention solves this need by providing a balanced gaming environment with high “playability”. Playability embraces three various aspects from the player and operator perspective: (1) ease of play, (2) player experience, and (3) profitability.

The invention may provide an easy-to-comprehend playing surface and the game may provide the player(s) with a selection of bets that are easy to comprehend to an inexperienced player. Furthermore, the pace of gameplay can be governed by the operator. Therefore, a variety of tables could host varying degrees of gameplay pace. The ability to vary the pace of play adds value to the player experience and to the operator's revenue stream. Player experience may also be enhanced by allowing multiple players to gather around the playing surface, adding the element of community to the game. In addition, the invention provides a level of profitability similar to the levels that an operator of a table game would expect in a casino setting.

The invention can be described as a method of playing a card game with at least one player. In one embodiment, the method includes providing a plurality of cards, requiring the at least one player to announce at least one bet on an outcome of a first drawn card and/or a set of drawn cards, drawing the first card and three additional cards, and evaluating the at least one announced bets. In one embodiment, the method of playing a card game may be performed through the Internet.

Each card in the plurality of cards may have a suit, denomination, and color. The provided plurality of cards may be one or more standard 52-card decks. In one embodiment, the cards are provided electronically.

The at least one player is required to announce at least one bet on an outcome of a set of drawn cards from the plurality of cards. The bet predicts a suit, denomination, or color of a first drawn card from the set of drawn cards. The bet may also predict the suits, denominations, or colors of the set of drawn cards. In one embodiment, the at least one player may announce a bet after the first card is drawn.

The player can announce a wide variety of bets. For example, the player can announce a bet on an outcome of the first drawn card being red or black. In another example, the player can announce a bet on an outcome of the first drawn card having a denomination higher than 8 or lower than 8. In another example, the player can announce a bet on an outcome of the first drawn card having a specific denomination falling in the range of 2 to 10, Jack, Queen, King, or Ace. In another example, the player can announce a bet on an outcome of the first drawn card having a specific suit. In another example, the player can announce a bet on an outcome of the first drawn card being a specific card.

The player can also announce a bet on the outcome of the set of drawn cards. For example, the player can announce a bet on an outcome of the first drawn card and the first drawn card from the set of the three additional cards having a denomination of Jack, Queen, King, and/or Ace. In another example, the player can announce a bet on an outcome of the first drawn card and the first and second drawn card from the set of the three additional cards having a denomination of Jack, Queen, King, and/or Ace. In another example, the player can announce a bet on an outcome of the first drawn card and the three additional drawn cards having a denomination of Jack, Queen, King, and/or Ace.

Bets may be announced through an input device. In one embodiment, each player announces at least one bet electronically to a computer. For example, a bet may be announced using a touch screen monitor. In another example, the input device is a mobile phone.

A first card is drawn from the plurality of cards. Three additional cards are also drawn from the plurality of cards. The cards may be drawn any order. In some embodiments, the method may also include the step of displaying the set of drawn cards on a display. In another embodiment, the method further comprises the steps of transmitting the first drawn card to a player terminal, and transmitting the three additional drawn cards to the player terminal.

The at least one announced bet is evaluated by comparing the first drawn card and/or set of drawn cards and the at least one player's bet.

### DESCRIPTION OF THE DRAWINGS

For a fuller understanding of the nature and objects of the invention, reference should be made to the following detailed description taken in conjunction with the accompanying drawings, in which:

FIG. 1 is a diagram illustrating a method of playing a card game according to an embodiment of the present invention;

FIG. 2 is a diagram of a table used to announce bets according to an embodiment of the present invention;

FIG. 3 is a flowchart illustrating a sequential method of playing a card game according to an embodiment of the present invention;

FIG. 4 is a diagram of a system in which the method of playing a card game can be performed; and,

FIG. 5 is a diagram of a system in which the method of playing a card game can be performed over the Internet.

Other features of the invention can be found in the following description, the enclosed claims and/or the attached drawings.

### DETAILED DESCRIPTION OF THE INVENTION

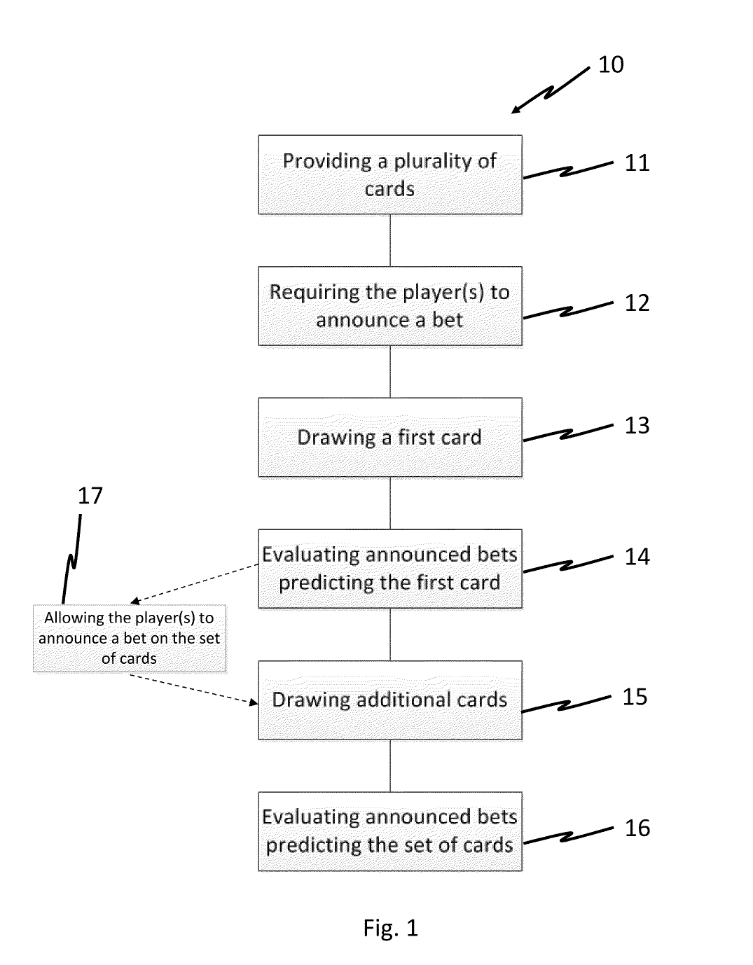

FIG. 1 is a diagram of a method of playing a card game 10 with at least one player according to an embodiment of the present invention. The game may involve a single player or multiple players. In one embodiment, the game is played with at least one player, but no more than 8 simultaneous players. Generally, a player is a human being, although in some embodiments, a player may be a computer-simulated player. A computer-simulated player may be programmed to exhibit certain personalities. For example, a computer-simulated player may have a cautious (i.e., risk averse) style of playing the card game. In another example, a computer-simulated player may have an aggressive (i.e., high risk, high reward) style of playing the card game.

In one embodiment, the player(s) “buy-in” to the table and may be subsequently provided markers by the House equivalent to the value of the buy-in. Throughout the specification, the House may refer to the operator facilitating the card game. For example, the House may be a person, a business entity, or a computer. In some embodiments, the player(s) buys-in using legal tender. In other embodiments, the player(s) may be given an arbitrary buy-in by the House. The buy-in does not need to be related to legal tender. For example, in one embodiment, the House provides each player with 50 markers as a buy-in. The player(s) then use these markers during gameplay. The markers may be any suitable marker used to track bets announced by players. For example, the markers may be colored chips that assist the House in tracking bets made by the player(s). The markers may be purely electronic and expressed through software.

In one embodiment, the method 10 of playing a card game comprises the step of providing 11 a plurality of cards, each card having a suit, denomination, and color. For example, the plurality of cards may be a standard 52-card deck. For the purposes of this invention, the standard 52-card deck contains 4 suits (diamonds, hearts, spades, and clubs), each suit having 13 cards (Ace, 2-10, Jack, Queen, and King). Two suits (diamonds and hearts) are red, and the other suits (spades and clubs) are black. In another example, the plurality of cards may be multiple standard 52-card decks. In a further example, the plurality of cards may comprise “n” cards, the cards having “m” suits, “x” denominations, and “z” colors, where n, m, x, and z are all integers.

Players may enter and exit (i.e., begin or stop playing) the card game at the beginning of each round. For example, a round may start with a betting phase where players are required to announce at least one bet and end with an evaluation phase after an entire set of cards is drawn. Drawn cards may be returned to the plurality of cards, or removed from the plurality of cards for a predetermined number of rounds.

The at least one player is required 12 to announce at least one bet on an outcome of a set of drawn cards from the plurality of cards. A bet comprises a prediction of an outcome and a bet magnitude associated with the prediction. For example, a player may announce a bet of $15 on the first drawn card being red. Here, the predicted outcome is the color of the first drawn card (red) and the bet magnitude is $15. In one embodiment, a bet may be announced verbally. In another embodiment, a bet may be announced by placing a marker onto a table. In another embodiment, the player(s) may announce bets electronically through an input device, such as a keyboard or touch screen. In another embodiment, the input device may be a laptop, mobile phone, or tablet computer.

The announced bet may attempt to predict a suit, denomination or color of a first drawn card from the set of drawn cards. The announced bet may also attempt to predict the suits, denominations, or colors of a subset of the set of drawn cards. For the purposes of this specification, the “first drawn card” will be interchangeably referred to as the “Draw Card.” For example, the player may announce a bet predicting that the Draw Card will be either red or black. In another example, the player may announce a bet predicting that the Draw Card will be between a range of denominations (e.g., a “low” denomination between 2-7, or a “high” denomination between 9 and ace). Other bets may include predicting the denomination of the Draw Card (e.g., a 9), the suit of the Draw Card (e.g., a diamond), and the suit and denomination of the Draw Card (e.g., a 3 of clubs). In one embodiment, the denomination range bets may not include the number 8. By removing the number 8, the odds become more favorable to the House.

A player may announce a bet on a subset or the complete set of drawn cards. Excluding the Draw Card, the remaining cards in the set of drawn cards will be interchangeably referred to as the “Chasers.” Although exemplary embodiments utilizing three Chasers are discussed, the present invention may also be played using two, or more than 3 Chasers.

In one embodiment, a player may announce a bet on an outcome of the Draw Card and the first Chaser both having a denomination of Jack, Queen, King, and/or Ace. In another embodiment, a player may announce a bet on an outcome of the Draw Card and the first and second Chasers all having a denomination of Jack, Queen, King, and/or Ace. In one embodiment, a player may announce a bet on an outcome of both the Draw Card and all the Chasers having a denomination of Jack, Queen, King, and/or Ace.

The order of the Chasers may be relevant to evaluating the announced bet. For example, an announced bet predicting 3 Kings would lose if the sequential set of drawn cards is King, 8, King, King. However, in other embodiments, that announced bet may be considered a winning bet.

In another embodiment, a player may announce a bet predicting the color or suits of both the Draw Card and Chasers. For example, a player may announce a bet predicting that the Draw Card and Chasers will all be the same color, the same suit, or of different suits.

The method of playing a card game also comprises the step of drawing 13 the first card from the plurality of cards. The card may be drawn by hand by a dealer, mechanically using an automatic card dispensing device, or electronically through a simulated plurality of cards. The card may or may not be immediately shown to the player(s).

The method of playing a card game also comprises the step of evaluating 14 the at least one announced bet by comparing the first drawn card (Draw Card) and the at least one player's bet. If the player's bet was correct, the House will pay the player an amount proportional to the magnitude of the bet announced by that player. The ratio of the payout may vary. For example, the ratio of the payout may be proportional to the probability of the realization of the announced bet. For example, the payout ratio may be low if the announced bet predicts the color of the first drawn card and the payout ratio may be high if the announced bet predicts a specific card. If the player's announced bet proves to be inaccurate, the House collects the bet magnitude.

The method of playing a card game also comprises the step of drawing 15 additional cards from the plurality of cards. For example, three additional cards may be drawn from the plurality of cards. Like the first drawn card, these cards may be drawn by hand by a dealer, mechanically using an automatic card dispensing device, or electronically through a simulated plurality of cards.

The method of playing a card game also comprises the step of evaluating 16 the at least one announced bet by comparing the set of drawn cards and the at least one player's bet.

In one embodiment, the player(s) may be allowed 17 to announce a bet after the first card is drawn. The payout ratios may be different for bets announced after the first card is drawn than before the first card is drawn. For example, the payout ratios may be less after the first card is drawn because the odds of certain outcomes are more favorable.

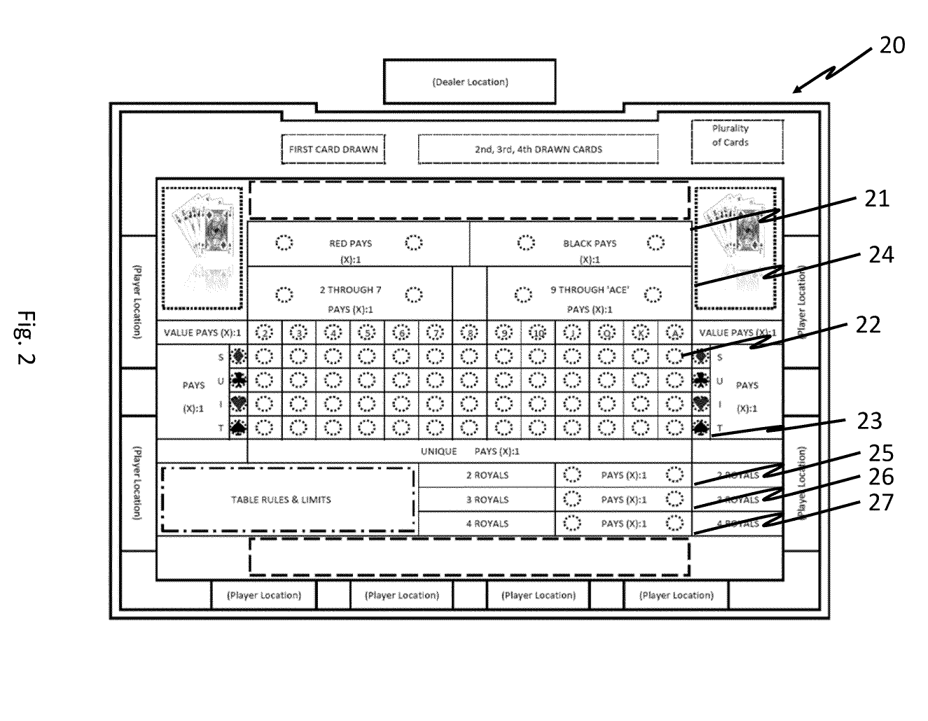

A player may announce a bet using a playing surface such as a table. FIG. 2 depicts one embodiment of a table. The table 20 may have regions indicating specific bets. In this embodiment, the player(s) may place markers on location 21 to announce a bet predicting the color of the Draw Card. The player(s) may place markers on location 22 to announce a bet predicting a specific Draw Card. The table may also contain a location 23 where a player can announce a bet predicting the suit of a Draw Card, a location 24 where a player can announce a bet predicting a range in which the denomination of the Draw Card will fall, and locations 25, 26, and 27 where the player can announce a bet predicting the denominations of at least part of the set of drawn cards.

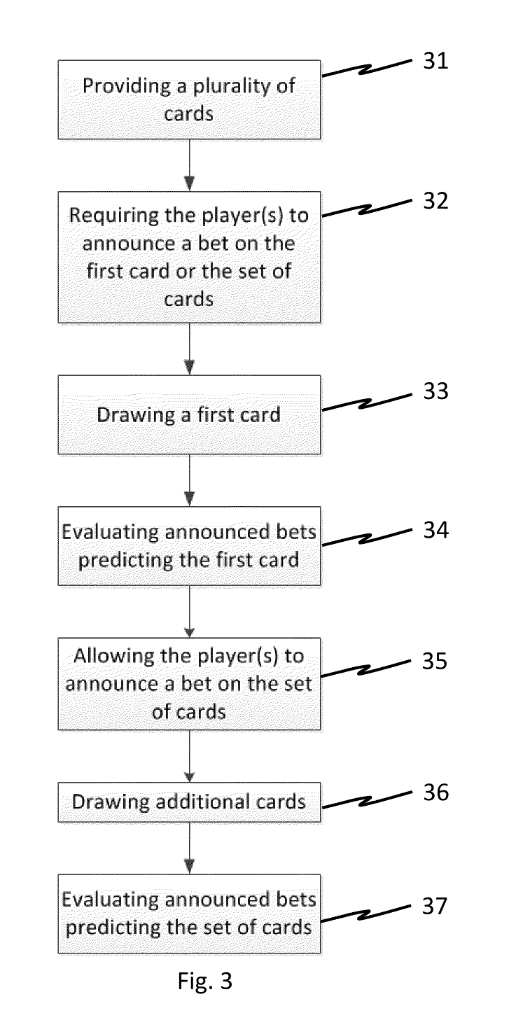

In another embodiment show in FIG. 3, the order of the steps may be sequential. For example, the method may comprise providing 31 a plurality of cards, then requiring 32 the player(s) to announce a bet on the first card or the set of cards. After the bets are announced, the first card is drawn 33 and the announced bets are evaluated 34. In some embodiments, the player(s) may then be allowed to announce new bets predicting the outcome of the set of drawn cards 35. Regardless, additional cards are then drawn 36 and the announced bets are evaluated 37 against the set of drawn cards.

In one embodiment, the player(s) may be allowed (or required) to announce a bet on another player's (or players') announced bet(s). For example Player A may be allowed to announce a bet on the successful outcome of Player B announced bets. In another embodiment, Player A's ability to announce a bet on the success of Player B's announced bets is based on the number of bets Player B makes. For example, Player A may only be allowed to place a bet on the success of Player B's bets if Player B places 3 or more bets. In another embodiment, multiple players, within the same or different games, may pool their bets and bet on the outcome of Player C's bets.

In another embodiment, the player(s) may be allowed (or required) to announce a “progressive” bet. A progressive bet is a bet predicting a specific event (i.e., the drawing of a specific set of cards) where the progressive payout accumulates. The payout may accumulate over time and/or increase based on the magnitudes of some or all bets placed on a specific table, or on multiple tables. The progressive payout may reset to a predetermined level after the specific event occurs. In another embodiment, the progressive payout may reset after a player announces and wins a progressive bet. A player may be restricted on placing a progressive bet unless certain conditions are satisfied. For example, a player may only be permitted to announce a progressive bet after announcing three bets in a single round. In another example, a player may only be permitted to announce a progressive bet after announcing a bet or bets greater than a predetermined total bet magnitude.

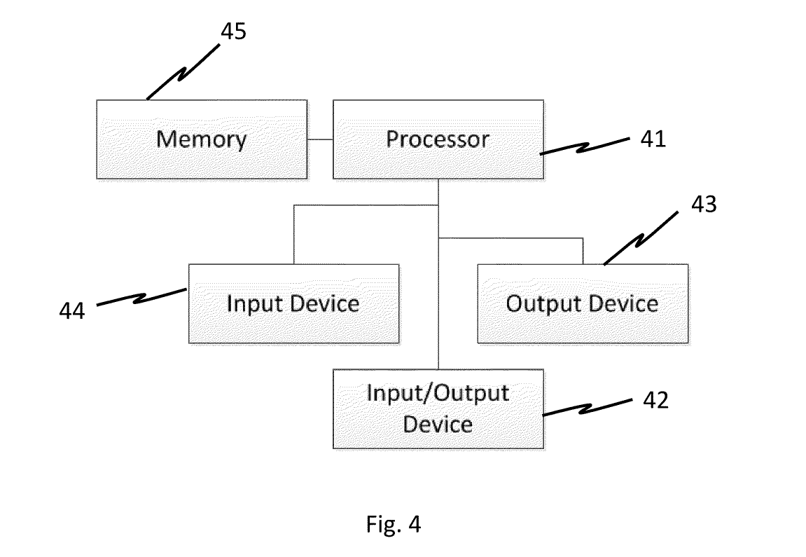

In one embodiment shown in FIG. 4, the method of playing the game may be electronic. In this embodiment, a processor 41 provides a plurality of cards, each card having a suit, denomination, and color. A player may use an input device 44 in communication with the processor 41 to announce at least one bet on an outcome of a set of drawn cards from the plurality of cards. The magnitude of the bet may be deducted from a player's account stored in memory 45. The memory 45 may be read-only memory, a hard drive, or some other suitable digital storage medium. The account may represent actual currency or a virtual currency, such as points. In one embodiment, the input device 44 may be a touch screen. The processor 41 randomly draws a card from the plurality of cards and may display the card on an output 43 device such as a monitor or display. The output device 43 and input device 44 may be joined together as a single input/output device 42, such as a touch-screen monitor. The remainder of the set of cards is drawn and displayed on the output device 43. The processor 41 evaluates the at least one announced bet and compensates the player accordingly if the bet was accurate. The player may be compensated by adjusting the account stored in memory 45.

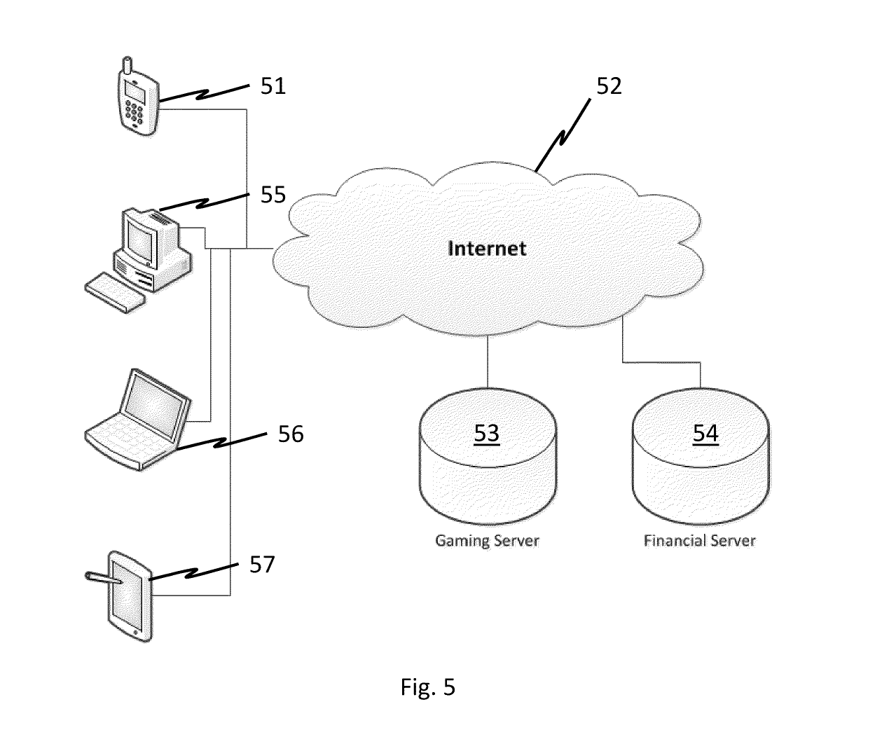

In another embodiment shown in FIG. 5, the game may be played over the Internet 52. For example, the player(s) may communicate with a central gaming server 53 over the Internet 52 using computing devices. The central gaming server 53 may be a single server or a collection of servers configured to operate the game. A player may connect to the central gaming server using a personal computer 55, laptop 56, tablet 57, mobile device, or mobile phone 51. Player(s) may connect to the same gaming session regardless of the device the player uses. The players may buy-in to the game using legal tender. For example, the central gaming server 53 may communicate with financial server 54 which contains financial information for a player. The player may direct the central gaming server 53 to withdraw the buy-in from the financial server 54. The central gaming server 53 requires the player(s) to announce at least one bet predicting the Draw Card and/or Chasers. The central gaming server 53 provides a plurality of cards and draws a first card by random. The color, suit, and denomination of the card may be transmitted from the central gaming server 53 to the player devices 51, 55, 56, 57 through the Internet 52. The central gaming server 53 evaluates the at least one announced bets and compensates the player(s) according to predefined payout ratios. The payout ratios may vary based on the number of player(s) in the same instance of a game. The player may direct the central gaming server 53 to deposit the payout with financial server 54.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

We claim:

1. A method of playing a card game with at least one player comprising:
providing a plurality of cards, each card having a suit, denomination, and color;
requiring the at least one player to announce at least one bet on an outcome of a set of drawn cards from the plurality of cards, the bet predicting a suit, denomination, or color of a first drawn card from the set of drawn cards, or the suits, denominations, or colors of the set of drawn cards;
drawing the first card from the plurality of cards;
evaluating the at least one announced bet by comparing the first drawn card and the at least one announced bet;
drawing three additional cards from the plurality of cards; and,
evaluating the at least one announced bet by comparing the set of drawn cards and the at least one announced bet.

2. The method of claim 1, wherein the at least one player may announce a bet after the first card is drawn.

3. The method of claim 1, wherein the plurality of cards is one or more standard 52-card deck(s).

4. The method of claim 3, wherein the player can announce a bet on an outcome of the first drawn card being red or black.

5. The method of claim 3, wherein the player can announce a bet on an outcome of the first drawn card having a denomination higher than 8 or lower than 8.

6. The method of claim 3, wherein the player can announce a bet on an outcome of the first drawn card having a specific denomination falling in the range of 2 to 10, Jack, Queen, King or Ace.

7. The method of claim 1, wherein the player can announce a bet on an outcome of the first drawn card having a specific suit.

8. The method of claim 1, wherein the player can announce a bet on an outcome of the first drawn card being a specific card.

9. The method of claim 3, wherein the player can announce a bet on an outcome of the first drawn card and the first drawn card from the set of the three additional cards, having a denomination of Jack, Queen, King, and/or Ace.

10. The method of claim 3, wherein the player can announce a bet on an outcome of the first drawn card and the first and second drawn card from the set of the three additional cards, having a denomination of Jack, Queen, King, and/or Ace.

11. The method of claim 3, wherein the player can announce a bet on an outcome of the first drawn card and the three additional drawn cards, having a denomination of Jack, Queen, King, and/or Ace.

12. The method of claim 1, further comprising the step of receiving bets using an input device.

13. The method of claim 12, wherein the input device is a touch screen monitor.

14. The method of claim 12, wherein the input device is a mobile phone.

15. The method of claim 1, further comprising the step of displaying the set of drawn cards on a display.

16. The method of claim 1, wherein each player announces at least one bet electronically to a computer.

17. The method of claim 16, wherein the computer provides the plurality of cards electronically.

18. The method of claim 17, further comprising the steps of transmitting the first drawn card to the at least one player, and transmitting the three additional drawn cards to the at least one player.

19. The method of claim 16, wherein the computer is a mobile phone.

20. The method of claim 1, wherein at least one of the steps is performed over the Internet.
